(19) United States
(12) Patent Application Publication
(10) Pub. No.: US 2026/0285282 A1
(43) Pub. Date: Sep. 24, 2026

(54) SYSTEM FOR MONITORING THE STATUS OF A BRAKING SYSTEM, METHOD FOR ESTIMATING OF THERMAL PROPERTIES OF A BRAKING ELEMENT AND METHOD FOR ESTIMATING OF THERMAL EXCHANGE PARAMETERS OF A BRAKING SYSTEM

(71) Applicant: ITT Italia S.R.L., Lainate (Milano) (IT)

(72) Inventors: Enrico Bibbona, Torino (IT); Francesca Collini, Rocca San Giovanni (Chieti) (IT); Stefano Serra, Saluzzo (Cuneo) (IT); Pietro Macchi, Torino (IT); Umberto Vignolo, Porte (Torino) (IT)

(21) Appl. No.: 19/472,571

(22) PCT Filed: Mar. 29, 2024
(86) PCT No.: PCT/EP2024/058757

§ 371 Date: Oct. 3, 2025

(30) Foreign Application Priority Data
Apr. 4, 2023 (IT) 102023000006639

(51) Int. Cl. B60T 17/22; F16D 66/00; G01K 1/02; G01K 1/14

(52) U.S. Cl. CPC B60T 17/22; F16D 66/00; G01K 1/026; G01K 1/14; F16D 2066/001; F16D 2066/006

(57) ABSTRACT

In one aspect the invention relates to a system for monitoring the status of a braking system (1) comprising at least one brake comprising at least one braked rotor (10), at least one braking element (20) comprising at least one block of the friction material (21), a support (23) of the block of friction material (21) and at least one temperature sensor (30) configured and arranged for sensing a direct temperature measurement performed at an internal point of said braking system, a plurality of sensors (400) for sensing physical and dynamic conditions of the braking system (1) and at the boundary of the braking system (1), wherein the at least one electronic control unit (100) comprises at least a plurality of algorithms (200) configured for at least the acquisition, process archive and communication of the data detected by the plurality of sensors (400), wherein the at least one electronic control unit (100) comprises at least one mathematical model (300) configured as a braking system thermal model (BSTM) for the evaluation and presentation of an estimate (500) of the thermal status of the braking system (1), wherein the mathematical model (300) is configured to use as input data at least the temperature acquired by the at least one temperature sensor (30) to estimate (500) the thermal status of said braking system (1) processed by the mathematical model (300). In further aspects the invention relates to a method for estimating of thermal properties of a braking element and a method for estimating of thermal power exchange parameters of a braking system.

### STATE OF THE ART

This description refers to a system for monitoring the status of a braking system via acquisition of a temperature signal.

### SUMMARY

Systems for monitoring the status of a braking system by acquiring boundary data of the braking system and processing this information by a mathematical model that returns an estimate of the state of the system have long been known.

Such known monitoring systems are notoriously ineffective, as the returned estimate turns out to be poorly reliable, and often in disagreement and inconsistent with experimentally measured measurements.

There is therefore a need to improve the structure of a mathematical model monitoring system.

The technical task that the present invention proposes is, therefore, to realise a system for monitoring the status of a braking system with a mathematical model that can eliminate the technical drawbacks complained of by the known technique.

In the context of this technical task, one aim of the invention is to realise a system for monitoring the status of a brake system with a mathematical model that provides a reliable estimate of the status of the brake system.

A further purpose of the present invention is to realise a system for monitoring the status of a braking system with a mathematical model that can be applied to any braking system comprising a brake and a braked rotor, typically but not limited to the automotive, railway, test benches, and turbine sectors.

It is also the aim of the invention to realise a system for monitoring the status of a braking system with a mathematical model that can provide a reliable estimate of the rotor temperature and temperature distribution in a braking element.

The Applicant of this patent holds several patents and patent applications protecting the innovative features and applications of a ‘smart’ type braking element, in jargon ‘smart pad’, typically comprising a block of friction material, a possible compensation layer and a backing plate configured for one or more sensors, typically of force, normal and/or shear, and/or temperature.

The technical task, as well as these and other purposes, according to the present invention are achieved by realising a system for monitoring the status of a braking system comprising at least one brake comprising at least one braked rotor, at least one braking element comprising at least one block of the friction material, a support of the block of friction material and at least one temperature sensor configured and arranged for sensing a direct temperature measurement performed at an internal point of said braking system, a plurality of sensors for sensing physical and dynamic conditions of said braking system and at the boundary of said braking system, at least one electronic control unit comprising at least a plurality of algorithms configured for at least the acquisition, process archive and communication of the data detected by said plurality of sensors, characterized in that said at least one electronic control unit comprises at least one mathematical model configured as a braking system thermal model (BSTM) for the evaluation and presentation of an estimate of the thermal status of said braking system, wherein said mathematical model is configured to use as input data at least the temperature acquired by said at least one temperature sensor to estimate the thermal status of said braking system processed by said mathematical model.

In a preferred form of execution, the temperature sensor is configured and arranged to detect the temperature of the braking element support.

In a preferred form of execution, the estimation of the status of the braking system of the mathematical model (BSTM) takes place in real time.

In a preferred form of execution, the estimation of the mathematical model of the status of the braking system includes the estimation of the temperature of the braked rotor.

In a form of execution, the estimation of the mathematical model of the status of the braking system includes the estimation of the temperature distribution in the friction material block, calculated as a three-dimensional function of time and space.

In one form of execution, the mathematical model of the status of the braking system is configured to include as input data the acquisition of at least one sensor data of the physical and dynamic conditions of the braking system and the boundary of the braking system.

In one form of execution, the mathematical model estimation of the status of the braking system is configured to estimate the thermal properties of the braking element.

In one form of execution, the mathematical model of the braking system status is configured to estimate the energy exchange parameters of the braking system.

Other features of the present invention are also defined in subsequent claims.

### BRIEF DESCRIPTION OF THE DRAWINGS

Further features and advantages of the invention will become more apparent from the description of a preferred but not exclusive form of execution of a system for monitoring the status of a braking system according to the invention, illustrated by way of illustration and not limitation in the accompanying drawings, in which

FIG. 1 schematically shows an architecture of a braking system status monitoring system according to the invention;

FIG. 2 shows a block diagram of the mathematical model for estimating braking system temperatures;

FIG. 3 shows schematically a data collection architecture for estimating the thermal properties of the braking element;

FIG. 4 shows a block diagram of the mathematical model for estimating the thermal properties of the braking element;

FIG. 5 schematically shows a data collection architecture for the estimation of braking element heat transfer parameters;

FIG. 6 shows a block diagram of the mathematical model for estimating the thermal power exchange parameters of the braking system;

FIG. 7 shows in a three-dimensional graph the thermal model of the temperature in a braking element.

FIG. 8 shows a block diagram of an optimiser.

### DETAILED DESCRIPTION OF SOME FORMS OF REALISATION

The following detailed description refers to the attached drawings, which form part of it.

In drawings, similar reference numbers typically identify similar components, unless the context indicates otherwise.

The illustrative forms of realisation described in the detailed description and drawings are not intended in a limiting sense.

Other forms of realisation may be used, and other modifications may be made without departing from the spirit or scope of the subject matter depicted here.

The aspects of this description, as generally described in this context and illustrated in the figures, can be arranged, substituted, combined, and designed in a wide variety of different configurations, all of which are explicitly contemplated and are part of this description.

### System Architecture

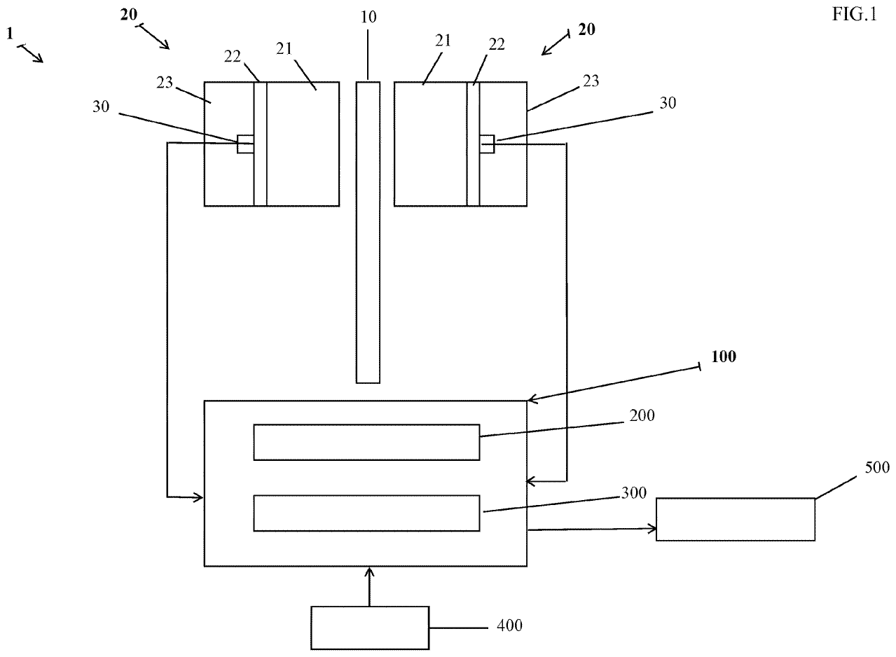

With particular reference to FIG. 1, the architecture of a system for monitoring the status of a braking system, collectively referred to as reference number 1, is shown.

The braking system 1 comprises at least one brake, which comprises at least one braked rotor 10 on which a braking element 20 acts in applying the brakes.

The braking element 20, only schematically shown in the figures, comprises at least a block of friction material 21, a possible compensation layer 22 and a support 23.

Favourably, in the braking system 1 at least one braking element 20 is of the “smart pad” type, and includes at least one temperature sensor 30, suitably and typically configured and arranged for detecting the temperature of the support 23.

The temperature sensor 30 can be a contact temperature sensor integrated in the support 23 or a non-contact temperature sensor.

In addition, temperature sensor 30 can be configured and positioned to detect a surface temperature of support 23 or an average temperature of support 23.

For example, the temperature sensor 30 can be placed on a support 23 surface facing the wearable block of friction material 21.

The temperature sensor 30 can be integrated into the support 23 and positioned flush with the surface of the support 23 facing the wearable block of friction material 21.

However, if the temperature of a surface of the substrate 23 is to be measured, then that surface may be a surface of the support 23 facing towards or in the opposite direction to the wearable block of friction material 21.

The temperature sensor 30 may be a separate component or may be screen-printed directly onto the support, which is typically made of metal. The braking system status monitoring system 1 further comprises at least one electronic control unit (ECU) 100 which, favourably, comprises at least one plurality of algorithms 200 configured for at least the acquisition, processing, storage and communication of data sensed and/or processed by auxiliary algorithms from a plurality of sensors 400 relating to a plurality of physical and dynamic quantities, specific to the braking system 1 and in the boundary of the braking system 1 itself.

Indicatively but not limitatively, this plurality of information may relate to ambient temperature, rotor speeds and accelerations, vehicle speeds and accelerations, driving style, brake pedal position, brake activation times and frequencies, pressures in the hydraulic circuits activating braking, speed and characteristics of cooling flows, etc.

Favourably, the electronic control unit (ECU) 100 includes at least one mathematical model 300 configured as a Braking System Thermal Model (BSTM) for the evaluation and presentation of an estimated 500 status of the braking system thermal 1.

Favourably and innovatively, the mathematical model (BSTM) 300 is configured to acquire as input data at least the temperature acquired by the temperature sensor 30, typically the temperature T_{back} of the support 23 of the braking element 20.

Advantageously and innovatively, the mathematical model (BSTM) 300 is configured to estimate 500 the status of the braking system 1 based on the temperature of the support 23 of the braking element 20 acquired by the temperature sensor 30.

### Estimation of Brake System Temperatures

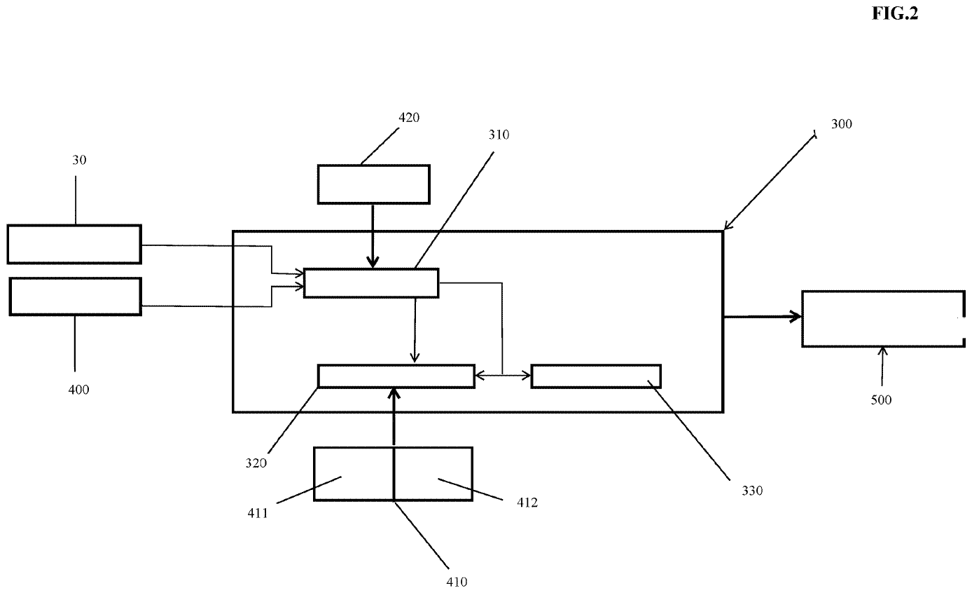

FIG. 2 shows a block diagram of the BSTM 300 mathematical model for estimating braking system 1 temperatures.

Estimation 500 of braking system 1 temperatures is performed by the mathematical model 300 (BSTM) in real time on the electronic control unit (ECU) 100.

Typically, the mathematical model (BSTM) 300 includes at least a block for the estimation of boundary conditions 310 (Boundary Condition Estimator, acronym BCE), at least a thermal model of the braking element 320 (Pad Thermal Model, acronym PTM), at least a thermal model of the rotor 330 (Rotor Thermal Model, acronym RTM).

Innovatively, according to the present invention, the temperature T_{back} detected by the at least one temperature sensor 30 of the support 23 is an input of the boundary condition estimation block (BCE) 310.

Advantageously, at least two different system architectures can be implemented: either the temperature sensor 30 can be directly connected to the Electronic Control Unit (ECU) 100 as depicted in the figures, or the temperature sensor 30 can be connected to a further system electronic control unit, not shown in the figures.

The measurement of the temperature sensor 30, suitably processed by the ECB block if necessary, is used as the boundary condition of the PTM model on support 23 side for the mathematical model BSTM 300 for the estimation 500 of the thermal status of the braking system, including the temperature of the braking element 20 on support 23.

The temperature estimated by the mathematical model BSTM 300 at that point is thus favourably and innovatively constrained by the actual temperature T_{back} measured by temperature sensor 30. The use of the temperature T_{back} detected by sensor 30 as a boundary condition requires that the predictions of the BSTM mathematical model coincide with this temperature at support 23.

The BSTM mathematical model will then make an estimate of the temporal temperature evolution within the braking element 20 having constrained one of the two extremes (support 23) to a measured temperature.

Any differences between the temperature values of the braking element 20 on the support 23 estimated by the mathematical model (BSTM) 300 and actual temperature values T_{back} detected by the temperature sensor 30 are favourably processed by the mathematical model (BSTM) 300 to calibrate the algorithm of the mathematical model (BSTM) 300 accordingly and appropriately in real time.

The temperature sensor 30 is also used by the Boundary Condition Estimation Block (BCE) 310 to calculate the thermal power exchange which is both the boundary condition for the thermal model of the braking element 320 (Pad Thermal Model, acronym PTM) on the interface side friction material block 21/rotor 10, and the input for the thermal model of the rotor 330 (Rotor Thermal Model, acronym RTM).

The data collected by the plurality of external sensors 400 are also inputs to the boundary condition estimation block (BCE) 310: these inputs are appropriately processed to calculate the thermal exchange power which is both boundary condition for the thermal brake element model (PTM) 320 on the interface side friction material block 21/rotor 10, and for the input to the rotor thermal model (RTM) 330.

Favourably, the Boundary Condition Estimation Block (BCE) 310 is configured to receive and process additional separately estimated thermal power exchange parameters 420.

Favourably, the braking element thermal model (PTM) 320 is configured to receive and process additional thermal properties and characteristics 410 of the braking element 20, both estimated thermal properties and characteristics 411 and measured thermal properties and characteristics 412.

The mathematical model 300 (BSTM) proposes in real time as a result an estimate 500 of the thermal status of the braking system 1: advantageously, the estimate 500 includes, for example but not limited to, the temperature Tᵣₒₜ of the rotor 10 and the temperature at the interface side block of friction material 21/rotor 10.

Advantageously, estimation 500 includes but is not limited to estimating the temperature distribution Temp_{pad} in the braking element 20.

Advantageously, the estimated 500 can be used in real time, e.g. but not limited to, for the notification of alarms relating to rotor temperature, rotor/braking element interface temperature with the indication of ‘fading’ phenomena, i.e. the rapid and sudden degradation of the friction coefficient of the friction material block 21 of the braking element 20 due to temperature, for the general vehicle monitoring system, for compensation in closed loop applications such as BBW and EMB applications, as input for other algorithms dedicated to the estimation of the performance/condition of the braking system (e.g. residual resistance estimation, ABS detection, Self Trigger, . . . ).

The mathematical model 300 (BSTM) can also be favourably used under post-processing conditions, for at least one estimate of the thermal properties of the braking element 20 and/or for at least one estimate of the thermal power exchange parameters of the braking system 1 for the fine-tuning of the mathematical model.

### Estimation of the Thermal Properties of the Braking Element

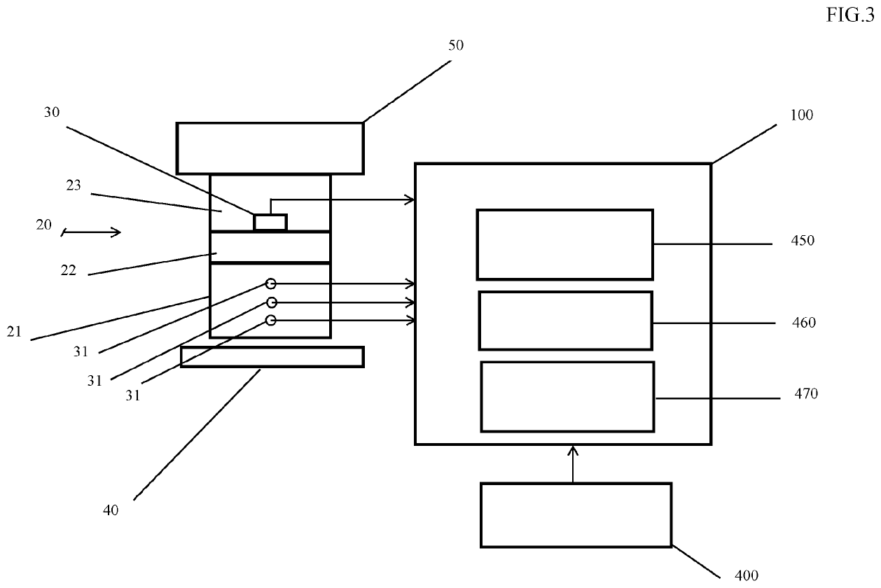

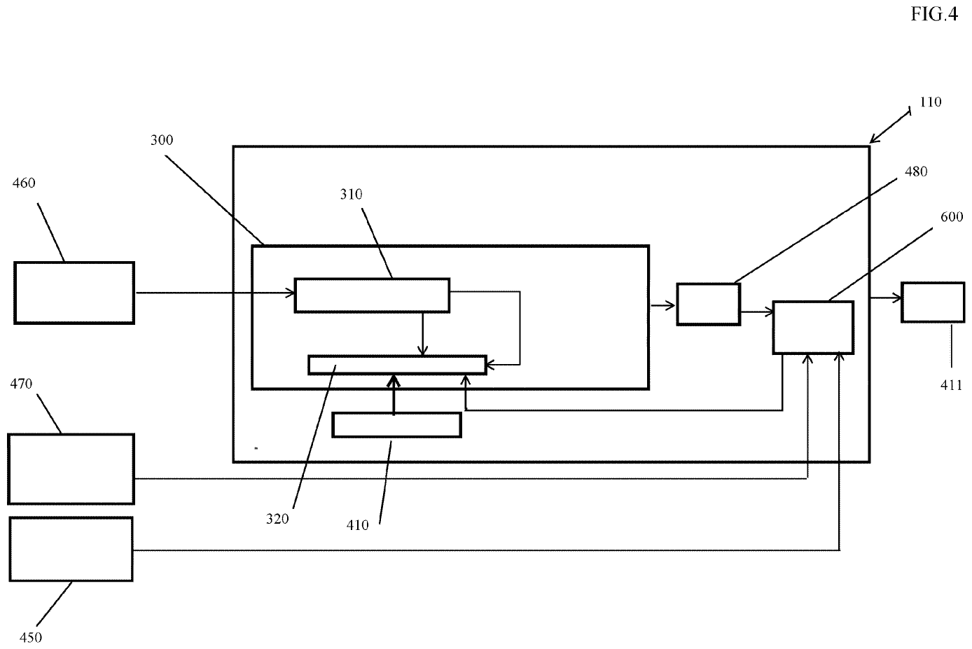

FIG. 3 schematically shows a data collection architecture for the estimation of the thermal properties 411 of the braking element 20; FIG. 4 shows a block diagram of the mathematical model for the estimation of the thermal properties 411 of the braking element 20.

The estimation of the thermal properties of braking element 20 is performed in post-processing using data acquired during a static bench test in the laboratory.

The braking element 20 is pressed/supported on a hot plate 40 at a controlled and constant temperature above that of the braking element 20 on the side of the friction material block 21.

The braking element 20 on the support 23 side is thermally insulated by the thermal insulation element 50.

The friction material 21 is suitably equipped with at least one, typically a plurality of temperature detectors 31, typically thermocouples of a known type arranged along the thickness of the material.

The values measured by the temperature sensor 30 and the plurality of temperature detectors 31 are acquired during the heating phase of the brake element 20 on the hot plate 40.

The data acquired during the static braking element test 20 and the data from the external sensors 400 are sent to and collected by the electronic control unit 100 and sorted as ‘smart pad’ sensor temperature data 450, external sensor data 460 (e.g. hot plate temperature 40), reference temperature data 470.

These data collected from the static test are then processed by a Model Tuning Block 110 (Model Tuning Block, acronym MTB) of the model of the thermal properties of the braking element, comprising at least the mathematical model (BSTM) 300 and an optimiser 600.

In the present configuration, in the mathematical model (BSTM) 300, the thermal model of the rotor (RTM) 330, which is not the subject of the static test, is of course not activated, but only the thermal model of the braking element (PTM) 320 is activated.

Support temperature sensor data 450 and reference temperature sensor data 470 are compared in the optimiser 600 with the estimated temperature 480 of the braking element 20 estimated by the mathematical model (BSTM) 300, for the estimation of the thermal property parameters 411 of the braking element 20.

The data from the external sensors 460 are input to the boundary condition estimation block (BCE) 310, and are used as the boundary condition for the thermal model of the temperature on the interface side of friction material block 21/rotor 10, in the test coinciding with the temperature of the heating plate 40.

Since support 23 side is thermally insulated, the boundary condition for the thermal model of brake element 20 on support 23 side is zero (no thermal power exchange).

The model tuning block (MTB) 110 thus returns a renewed and optimised estimate of the thermal properties and characteristics 411 of the braking element 20, which can favourably be used as input data in the braking element thermal model (PTM) 320 in the mathematical model (BSTM) 300.

### Estimation of Thermal Power Exchange Parameters

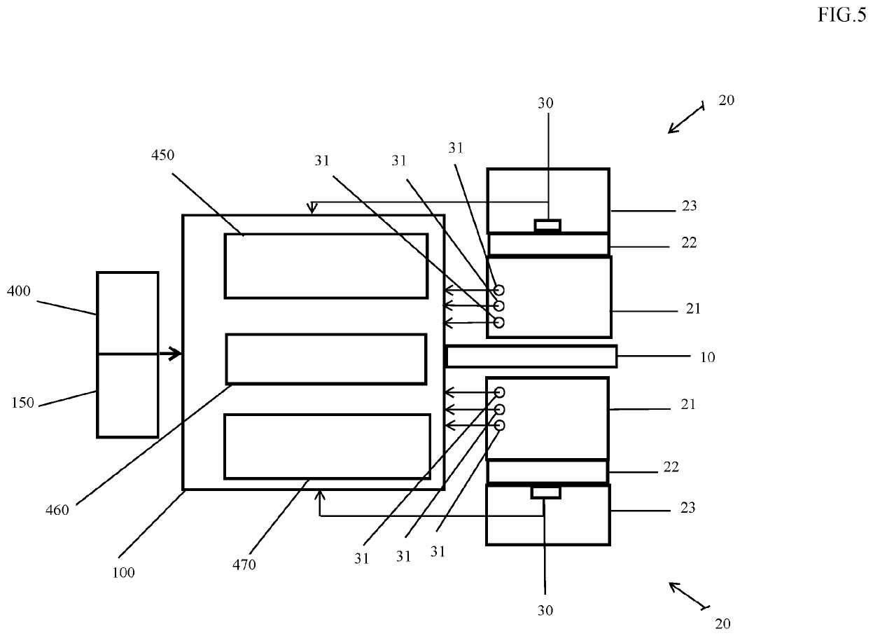

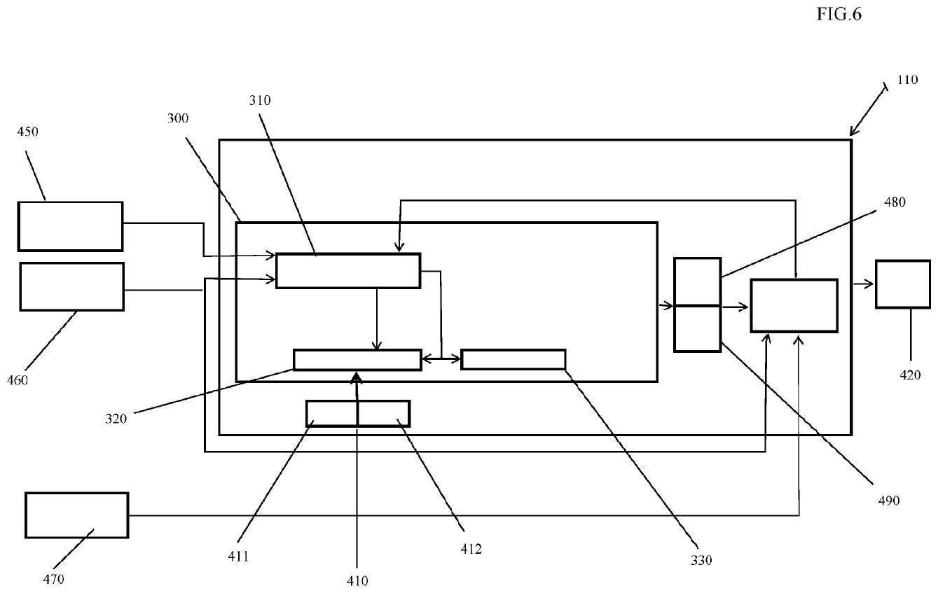

FIG. 5 schematically shows a data collection architecture for the estimation of the thermal power exchange parameters of braking system 1; FIG. 6 shows a block diagram of the mathematical model for the estimation of the thermal power exchange parameters of brake system 1.

The estimation of energy exchange parameters is performed in post-processing using the data acquired during the dynamic tests.

Dynamic tests can be performed using the braking system 1 of at least one target application (e.g. a motor vehicle) in real mode (e.g. during a long-term test) or a laboratory test, e.g. on a dynamic test bench capable of reproducing all conditions of the application in real mode (e.g. ambient temperatures, air flow . . . ).

Dynamic tests can be performed on a single vehicle/test bench or on a fleet of vehicles/test benches to increase statistics and improve performance.

The braking system may provide at least one or favourably a plurality of braked rotors 10, with at least one or favourably a pair of braking elements 20 per rotor.

The friction material 21 of each braking element 20 on board is suitably equipped with at least one, typically a plurality of temperature sensors 31, typically thermocouples of a known type, arranged along the thickness of the material.

The data acquired during the dynamic test of the braking element 20 and from the external sensors 400, and from any additional vehicle electronic control units 150 if present, are sent to and collected by the electronic control unit 100 and sorted as support temperature data 450, external sensor data 460, reference temperature data 470.

The data collected from the dynamic test are then processed by the model tuning block (MTB) 110 of the model of the braking system's thermal power exchange parameters, comprising at least the mathematical model (BSTM) 300 and an optimiser 600.

In the present configuration, both the braking element thermal model (PTM) 320 and rotor thermal model (RTM) 330 are activated in the mathematical model (BSTM) 300.

The data from the temperature sensors 450 on support side 23 are inputs to the boundary condition estimation block (BCE) 310, and are eventually processed and then used as a boundary condition for the thermal model of the temperature of braking element 20 on support 23 side: the estimated temperature on support 23 side is thus constrained by the actual measured temperature.

The Boundary Condition Estimation Block (BCE) 310 also calculates the heat output exchanged, which is used as the boundary condition for the temperature model of the braking element 20 interface friction material block 23/rotor 10, and as the input for the temperature model of rotor 10.

The data from the external sensors 460 are also inputs to the boundary condition estimation block (BCE) 310 and are used and processed to calculate the thermal power exchange, which is in turn both the boundary condition for the braking element 20 thermal model on the friction material interface side 23/rotor 10, and thus the input for the rotor 10 temperature model.

The data from the reference temperature sensors 470 and the temperature measurement of the rotor 10 (part of the external sensors 460) are compared in Optimiser 600 with the temperatures estimated by the mathematical model (BSTM) 300, typically the estimated temperatures 480 of the braking element 20 and the estimated temperatures 490 of the rotor 10, to estimate the parameters of the heat output exchanged 420 by the braking system 1.

The model fine-tuning block (MTB) 110 thus returns a renewed and optimised estimate of the heat output parameters 420 in the braking element 1, which can favourably be used as input data in the block for the boundary condition estimate (310) in the mathematical model (BSTM) 300.

### Estimation of Thermal Power Exchange

The heat output can be calculated in different ways depending on the sensors available. The functions presented are only given as examples.

The functions are characteristic of the specific braking system being estimated, and consider many parameters in addition to those specifically mentioned in the formulae (e.g. the distribution of hydraulic circuit pressure between different vehicle axles and right/left sides, rotor radius, brake element size, quantity and size of brake caliper pistons, thermal properties of the brake element and rotor, etc.).

Functions can belong either to physically motivated parametric families or to the output of a neural network or other machine learning algorithms.

The method of estimating energy exchange parameters allows the following to be estimated:
the vector of parameters of the equation used to calculate the power (α, δ, ε)
parameters for power distribution between pad and rotor during braking events (β, γ) A general function for calculating the power generated during a braking event can be written:

$$Pow\_in = {f}_{α} ( v , a , μ , w , d , P , T , … )$$

where
v [m/s] is the speed of the vehicle;
a [m/s²] is the longitudinal acceleration of the vehicle;
p [-] is a coefficient of friction;
w [rad/s] is the rotational speed of the wheel;
d [mm] is the thickness of the friction material block;
P [Pa] is the pressure in the brake's hydraulic circuit;
T [Nm] is the braking torque;
α, β, γ, δ, ε [-] are a vector of parameters;
and again
Temp_{pad} [° C.] is the temperature of the braking element (support and friction material);
Tempᵣₒₜ [° C.] is the temperature of the rotor;
Temp_{amb} [° C.] is the ambient temperature.

A general function for calculating the distribution of the power generated during a braking event between the braking element (Pow_in_pad) and the rotor (Pow_in-rotor) can be written:

$$Pow\_in \_pad = {g}_{β} ( {Pow\_}_{in} , {Temp}_{rot} , {Temp}_{pad} )$$

$$Pow\_in \_rotor = {h}_{γ} ( {Pow\_}_{in} , {Temp}_{rot} , {Temp}_{pad} )$$

A general function for power dissipation can be written:

$$Pow\_out \_pad = {i}_{δ} ( v , a , μ , w , d , P , T , {Temp}_{amb} … )$$

$$Pow\_out \_rotor = {l}_{ε} ( v , a , μ , w , d , P , T , {Temp}_{amb} … )$$

An example: a simple physical model comprising only the pressure in the hydraulic circuit and the wheel speed can be written:

$${f}_{α} = α ( μ wP ) / Δ t$$

### Descriptions of the Thermal Model of the Braking Element

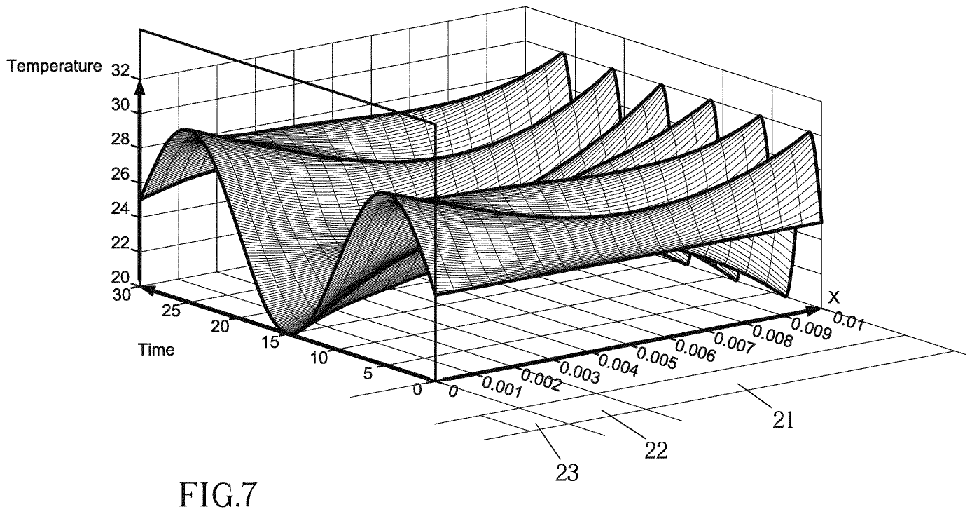

FIG. 7 shows a three-dimensional graph of the thermal model of a braking element 20.

The thermal model of the braking element maps in time and space (thickness of the braking element) the temperature evolution in the braking element when frictional braking power is applied on the rotor side.

The temperature of the braking element (Temp_{pad}) is calculated as a scalar function of time (t) and space (x), i.e. Temp_{pad} (x, t), the graph of which is a surface in 3D space.

The intersection of the graph of Temp_{pad} (x, t) and the Time/Temperature plane at the origin of the braking element thickness axis (i.e. where x=0) represents the estimated time evolution of the rear support temperature, i.e. Temp_{pad} (0, t).

### Brake Element Temperature Model Equations

Fourier equation:

$$\frac{\partial u}{\partial t} = \frac{k}{ρ C} \frac{{\partial }^{2} u}{\partial {x}^{2}}$$

where
u [K] is the temperature of the braking element as a function of space and time;

$$\frac{\partial u}{\partial t}$$

[l/s] is the first derivative of u with respect to time;

$$\frac{{\partial }^{2} u}{\partial {x}^{2}}$$

[l/m2] is the second derivative of u with respect to space;
k [W/(mK)] is the thermal conductivity;
ρ [kg/m3] is the density of the mass;
C [J/(kgK)] is the specific heat.

From the Fourier equation: 1D-1M braking element model (one dimension, one layer of friction material):

$$\frac{\partial u}{\partial t} = \frac{k 0}{ρ0 C 0} \frac{{\partial }^{2} u}{\partial {x}^{2}}$$

where two of the three physical parameters can be identified by the model using the incoming energy, the measured temperature of the medium, with or without reference temperature sensors. From the Fourier equation: 1D-2M braking element model (one dimension, two layers of friction material):

$$\frac{k}{{ρ}_{1} {C}_{1}} \frac{{\partial }_{1}^{2} {u}^{′}}{\partial {x}^{2}} = \frac{\partial {u}^{′}}{\partial t} \frac{{k}_{2}}{{ρ}_{2} {C}_{2}} \frac{{\partial }^{2} {u}^{′}}{\partial {x}^{2}} = \frac{\partial {u}^{′}}{\partial t}$$

where four of the six physical parameters can be identified by the model using the incoming energy, the measured temperature of the medium, and the reference temperature sensors.

If the system has no reference temperature sensors, only three physical parameters can be identified by the model.

### Optimisation

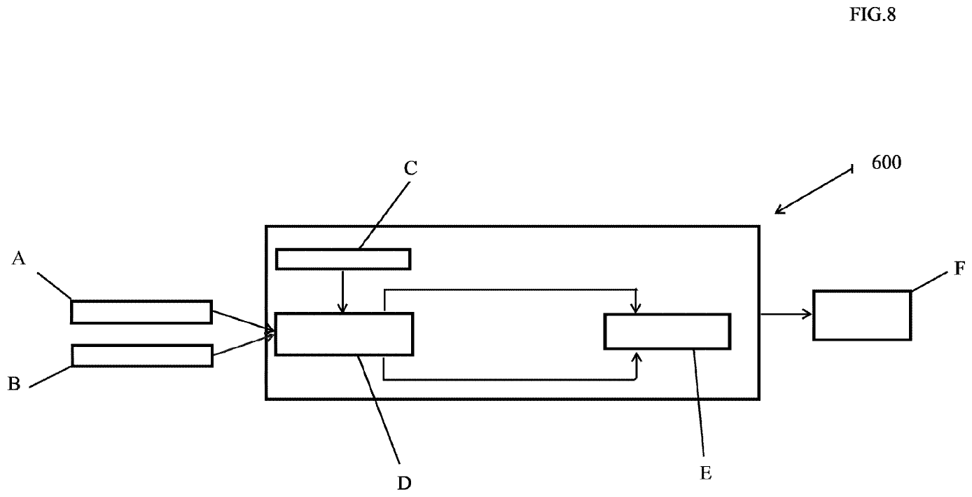

An optimisation process is schematically depicted in FIG. 8.

The optimisation processed in Optimiser 600 comprises a selection of a better parameter (or set of better parameters), with respect to the minimisation (or maximisation) of a given objective function, within a specified domain.

Numerical optimisation algorithms E are known iterative techniques used to solve optimisation problems.

They start with an initial assumption for the C parameters and generate a sequence of improved estimates (in terms of the objective function) until they end with an F solution.

The objective function D is defined by comparing estimated data A with observed data B.

The optimiser tries to minimise these differences.

The strategy used to switch from one estimate to another distinguishes one algorithm from another.

Various optimisation algorithms can be implemented:
Descent methods (gradient descent, . . . )
Evolutionary methods (genetic algorithms, . . . )
Search methods by configuration (Nelder-Mead simplex, . . . )

In practice, it was found that a system for monitoring the status of a braking system according to the invention is particularly advantageous for presenting an estimate of the status of the braking system calibrated in real time from the measured temperature of a braking element.

A particular advantage of a braking system status monitoring system according to the invention is the presentation in real time of an estimate of the braking system which can be used, also but not only, for the notification of alarms relating to rotor temperature, rotor/braking element interface temperature with the signalling of “fading” phenomena, for the general vehicle monitoring system, for compensation in closed circuit applications such as BBW and EMB applications, as input for other algorithms dedicated to the estimation of the performance/condition of the braking system (e.g. residual resistance estimation, ABS detection, Self Trigger, . . . ).

It is apparent that the system for monitoring the status of a braking system according to the invention can be applied to any braking system comprising a sensor of a direct measurement performed at an internal point of the same.

A braking system status monitoring system thus conceived is susceptible to numerous modifications and variations, all of which fall within the scope of the inventive concept as defined by the claims; moreover, all details are replaceable by technically equivalent elements.

In practice, the materials used, as well as the dimensions, can be any according to requirements and the state of the art.

1. A system for monitoring the status of a braking system comprising at least one brake comprising at least one braked rotor, at least one braking element comprising at least one block of the friction material, a support of the block of friction material and at least one temperature sensor configured and arranged for sensing a direct temperature measurement performed at an internal point of said braking system, a plurality of sensors for sensing physical and dynamic conditions of said braking system and at the boundary of said braking system, at least one electronic control unit comprising at least a plurality of algorithms configured for at least the acquisition, process archive and communication of the data detected by said plurality of sensors, characterized in that said at least one electronic control unit comprises at least one mathematical model configured as a braking system thermal model (BSTM) for the evaluation and presentation of an estimate of the thermal status of said braking system, wherein said mathematical model is configured to use as input data at least the temperature acquired by said at least one temperature sensor to estimate the thermal status of said braking system processed by said mathematical model.

2. The system for monitoring the status of a braking system of claim 1, characterized in that said temperature sensor is configured and arranged to detect the temperature (T_{back}) of said support of said braking element.

3. The system for monitoring the status of a braking system of claim 2, characterized in that said temperature sensor is a contact temperature sensor integrated in the support or a non-contact temperature sensor, and is configured and positioned so as to detect a temperature of a surface of the support or an average temperature of the support.

4. The system for monitoring the status of a braking system of claim 3, characterized in that said estimate of the status of said braking system of said mathematical model takes place in real time.

5. The system for monitoring the status of a braking system of claim 1, characterized in that said mathematical model comprises at least one block for estimating the boundary conditions, at least one braking element thermal model and at least one rotor thermal model.

6. The system for monitoring the status of a braking system of claim 1, characterized in that said estimate processed by said mathematical model on the status of said braking system comprises at least the estimate of the temperature (Tᵣₒₜ) of said braked rotor.

7. The system for monitoring the status of a braking system of claim 1, characterized in that said estimate of said mathematical model on the status of said braking system comprises the estimate of the distribution of the temperature in said braking element.

8. The system for monitoring the status of a braking system (1) of claim 7, characterized in that said estimate of the distribution of the temperature in said braking element is calculated as a three-dimensional function of time and space.

9. The system for monitoring the status of a braking system (1) of claim 1, characterized in that said mathematical model of the status of said braking system is configured to comprise as input data the acquisition of at least one data of at least one sensor of said plurality of sensors of physical and dynamic conditions of said braking system and at the boundary of said braking system.

10. A method for estimating the thermal properties of a braking element monitored by a system for monitoring the status of a braking system comprising:
setting up a static test in the laboratory where a braking element under thermal condition is pressed/rested on a hot plate at a controlled and constant temperature higher than that of a braking element on the side of the block of a friction material, the braking element on the side of a support being thermally insulated by a thermal insulation element, the block of friction material being suitably equipped with at least one, typically a plurality of temperature detectors;
heating the braking element on the hot plate and acquiring the temperature data detected by a temperature sensor and by the at least one, typically a plurality of temperature detectors;
sending the temperature data acquired during the static test by the temperature sensor and by the at least one, typically a plurality of temperature detectors and the data detected by external sensors to a electronic control unit;
processing the temperature data detected by the temperature sensor, by the plurality of temperature detectors and by the external sensors in a model tuning block of the model of the thermal properties of the braking element, comprising at least a mathematical model and an optimizer;
obtaining from the model tuning block an optimized estimate of the thermal properties and characteristics of the braking element;
employing the optimized estimate of the thermal properties and characteristics of the braking element as input data to a braking element thermal model in the mathematical model.

11. A method for estimating the thermal power exchange parameters of a braking system monitored by a monitoring system:
setting up a dynamic test on a braking system comprising at least one braking element of a target application, typically a motor vehicle, in real mode, or in the laboratory test, typically into a dynamic test bench capable of reproducing all the conditions of the application in real mode;
equipping a friction material of each braking element on board with at least one, typically a plurality of temperature detectors;
sending the temperature data acquired during the dynamic test of the braking element by a temperature sensor and by the and at least one, typically a plurality of temperature detectors, and by a external sensors, and by any further vehicle electronic control units if present, to the electronic control unit;
processing the temperature data acquired in a model tuning block of the thermal power exchange parameter model of the braking system comprising at least a mathematical model and an optimizer;
obtaining from a model tuning block an optimized estimate of parameters of the thermal power exchanged in the braking element;
employing the optimized estimate of the parameters of the thermal power exchanged in the braking element as input data to a block for estimating the boundary conditions in the mathematical model.

12. A system for monitoring the status of a braking system comprising at least one sensor for sensing a direct measurement performed at an internal point of said braking system, a plurality of sensors for sensing physical and dynamic conditions of said braking system and at the boundary of said braking system, at least one electronic control unit comprising at least one plurality of algorithms configured for at least the acquisition, process archive and communication of the data detected by said plurality of sensors, said at least one electronic control unit comprising at least one mathematical model configured as a braking system thermal model (BSTM) for the evaluation and presentation of an estimate of the thermal status of said braking system, wherein said mathematical model is configured to use as input data at least the measurement acquired by said at least one sensor of a measurement in order to estimate the thermal status of said braking system processed by said mathematical model.
